(19) United States
(12) Patent Application Publication
(10) Pub. No.: US 2009/0238487 A1
(43) Pub. Date: Sep. 24, 2009

(54) IMAGE PROCESSING APPARATUS AND IMAGE PROCESSING METHOD

(75) Inventors: Shiro Nakagawa, Hachioji-shi (JP); Masatoshi Okutomi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: Olympus Corporation, Tokyo (JP); National University Corporation, Tokyo (JP)

(21) Appl. No.: 12/401,823

(22) Filed: Mar. 11, 2009

(30) Foreign Application Priority Data
Mar. 13, 2008 (JP) 2008-064403

(51) Int. Cl. G06K 9/40; G06K 9/36

(52) U.S. Cl. 382/263; 382/264; 382/274; 382/286

(57) ABSTRACT

An image processing apparatus according to the present invention includes an image acquisition section acquiring a multiple overlapping image in which a subject image is multiplexed, a filtering section filtering the multiple overlapping image acquired by the image acquisition section, a similarity calculation section calculating similarity between overlapping images contained in the multiple overlapping image filtered by the filtering section, and an overlapping image displacement calculation section using the similarity obtained by the similarity calculation section to calculate overlapping image displacement in the multiple overlapping image.

### CROSS-REFERENCE TO RELATED APPLICATIONS

This application is based upon and claims the benefit of priority from prior Japanese Patent Application No. 2008-064403, filed Mar. 13, 2008, the entire contents of which are incorporated herein by reference.

### BACKGROUND OF THE INVENTION

1. Field of the Invention

The present invention relates to an image processing apparatus and an image processing method which acquire displacement between overlapping images from a multiple overlapping image in which an acquired subject image is multiplexed.

2. Description of the Related Art

Some conventional image acquisition apparatuses such as cameras provide the function of enabling a subject image to be acquired in a multiplexed manner. FIG. 11 shows one such a multiple overlapping image. The figure shows a double overlapping image of a “sparrow perching on a branch of a tree”.

The multiple overlapping image as used herein refers to images in general in which multiple subject images are overlappingly shown. Specifically, examples of the multiple overlapping image include images in which multiple subject images are overlappingly formed, ghost images in which the subject image is multiplexed under an electric or optical effect, flare images, aligned plural images, and images in which the subject image is multiplexed as a result of a failure in image processing during superimposition.

A technique has been proposed which measures overlapping image displacement in a multiple overlapping image, that is, the width of the “misalignment” between a plurality of subject images in the multiple overlapping image, to measure the distance to the subject.

Specifically, for example, Patent Document 1 (Jpn. Pat. Appln. KOKAI Publication No. 2006-32897) describes a technique for measuring the distance to a subject using a double overlapping image on a transparent plate. Patent Document 2 (Jpn. Pat. Appln. KOKAI Publication No. 7-135597) describes a technique for measuring the distance to a subject by utilizing a diaphragm device with a plurality of apertures to acquire a double overlapping image.

A method used in the above-described techniques to measure the displacement between overlapping images calculates an autocorrelation value that is the value of an autocorrelation function indicative of the autocorrelation of a multiple overlapping image. The method then searches the obtained autocorrelation value for a second peak to measure the overlapping image displacement.

An example of a formula for calculating the autocorrelation value is shown below.

$${y}_{2} ( i ) - {y}_{1} ( i + τ ) \\ R ( τ ) = \frac{{\sum }_{i ∈ Ω} ( {y}_{1} ( i ) - {\overline{y}}_{1} ) ( {y}_{2} ( i ) - {\overline{y}}_{2} )}{\sqrt{{\sum }_{i ∈ Ω} {( {y}_{1} ( i ) - {\overline{y}}_{1} )}^{2} {\sum }_{i ∈ Ω} {( {y}_{2} ( i ) - {\overline{y}}_{2} )}^{2}}} \qquad ( 1 )$$

(y1 and y2: pixel values of a triple overlapping image in which the images are misaligned by τ;
i: image coordinates;
Ω: calculation range;
y̅₁, y̅₂: average values of y1 and y2 within the calculation range)

FIG. 12 shows a variation in autocorrelation value associated with a variation in overlapping image displacement τ expressed by Formula 1. The autocorrelation value, the value of the autocorrelation function R(τ), is calculated to detect such a second peak as shown in FIG. 12, which is indicative of the level of the correlation between the overlapping images. Thus, the displacement between the overlapping images is measured.

More specifically, the difference in value τ between a first peak and the second peak is determined to be the actual overlapping image displacement. Here, the values τ of the peak tops of the first and second peak may be used. However, the above-described techniques are not limited to this method. The values τ corresponding to the first and second peaks determined by a well-known method may be appropriately used. A possible unit for the overlapping image displacement is the number of pixels. Here, the first and second peaks refer to peaks with the highest and second highest peak intensities.

In this case, the autocorrelation function is calculated in a one-dimensional space.

For example, provided that the direction of the displacement between the overlapping images in the multiple overlapping image is known, the overlapping image displacement can be searched for by one-dimensional search along the direction of the displacement between the overlapping images.

In the configuration that acquires a double overlapping image shown on the transparent plate as described in Patent Document 1 (Jpn. Pat. Appln. KOKAI Publication No. 2006-32897), optical information obtained by an optical calibration technique can be used to pre-acquire the direction of the displacement between the overlapping images.

FIGS. 13 and 14 show a configuration for obtaining optical information. FIG. 13 shows the relationship between an image acquisition device IP and multiple overlapping image formation means (transparent plate TP). That is, the multiple overlapping image formation means refers to an optical device which is provided in an image acquisition optical system installed in an image acquisition apparatus such as a camera and which can photograph the same subject via different optical paths to form a plurality of subject images of the same subject on the image acquisition device IP at different positions. FIG. 14 shows the direction of the displacement between overlapping images in a multiple overlapping image in a plane u-V in FIG. 13.

If the direction of the displacement between the overlapping images in the multiple overlapping image is unknown, the second peak may be detected in the measurement results of the autocorrelation value in two-dimensional space.

### BRIEF SUMMARY OF THE INVENTION

An aspect of the present invention includes an image acquisition section acquiring a multiple overlapping image in which a subject image is multiplexed, a filtering section filtering the multiple overlapping image acquired by the image acquisition section, a similarity calculation section calculating similarity between overlapping images contained in the multiple overlapping image filtered by the filtering section, and an overlapping image displacement calculation section using the similarity obtained by the similarity calculation section to calculate overlapping image displacement in the multiple overlapping image.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a functional circuit in an image processing apparatus according to a first embodiment of the present invention;

FIG. 2 is a flowchart showing a process of measuring overlapping image displacement according to the first embodiment;

FIG. 3 is a diagram showing the configuration of a Laplacian filter as an example of a high-pass filter according to the first embodiment;

FIG. 4 is a diagram showing the pass characteristics of an LOG filter as an example of a low-pass filter according to the first embodiment;

FIG. 5 is a diagram showing the pass characteristics of a Prewitt filter as an example of a high-pass filter according to the first embodiment;

FIG. 6 is a diagram showing the calculation results of the displacement between overlapping images according to the first embodiment;

FIG. 7 is a diagram showing the calculation results of the displacement between the overlapping images according to the first embodiment;

FIG. 8 is a diagram showing the calculation results of the displacement between the overlapping images according to the first embodiment;

FIG. 9 is a block diagram showing the configuration of a functional circuit in an overlapping image displacement measurement apparatus according to a second embodiment of the present invention;

FIG. 10 is a flowchart showing a process of measuring overlapping image displacement according to the second embodiment;

FIG. 11 is a diagram showing an example of a double overlapping image;

FIG. 12 is a diagram showing the relationship between the overlapping image displacement and autocorrelation value of the double overlapping image;

FIG. 13 is a diagram showing the relationship between an image acquisition device and multiple overlapping image formation means;

FIG. 14 is a diagram showing an image formation position varying direction of a multiple overlapping image; and

FIG. 15 is a diagram showing the calculation results of overlapping image displacement obtained without filtering.

### DETAILED DESCRIPTION OF THE INVENTION

### First Embodiment

A first embodiment of an image processing apparatus according to the present invention will be described with reference to the drawings.

Image signals shown below are all uncompressed digitized image signals. Filtering processes and the like are also arithmetically implemented using binary data. The arithmetic operations can be implemented by either hardware or software.

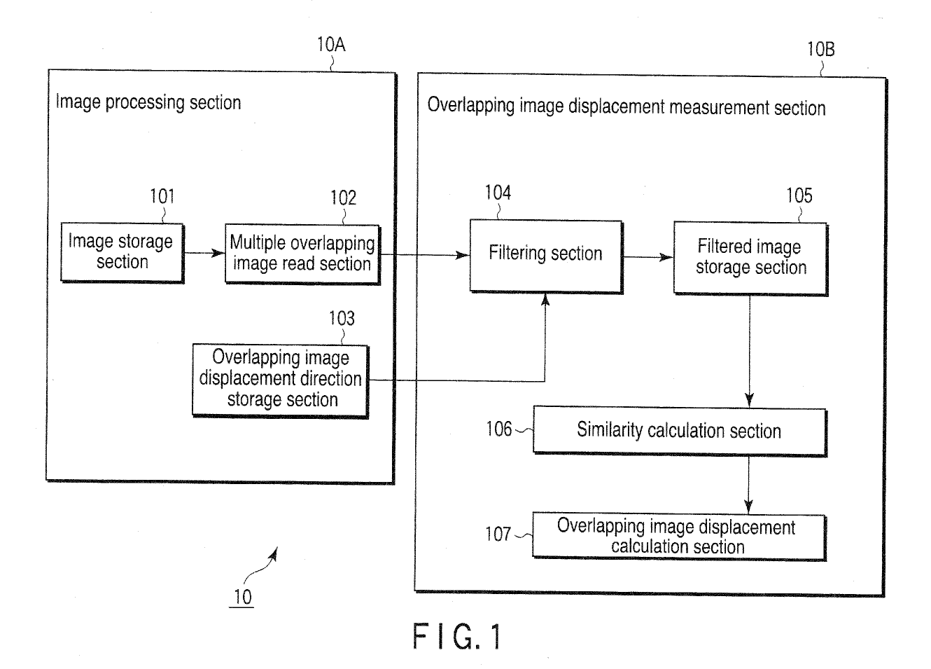

FIG. 1 shows the configuration of a functional circuit in an image processing apparatus 10 according to the first embodiment. Reference numbers 10A and 10B denote an image acquisition section and an overlapping image displacement measurement section, respectively.

The image acquisition section 10A is composed of an image storage section 101, a multiple overlapping image read section 102, and an overlapping image displacement direction storage section 103. A multiple overlapping image stored in the image storage section 101 is read to the overlapping image displacement measurement section 10B by the multiple overlapping image read section 102.

The overlapping image displacement direction storage section 103 stores information on the direction of the displacement between overlapping images in the multiple overlapping image stored in the image storage section 101. The contents stored in the image storage section 101 are read to the overlapping image displacement measurement section 10B.

The direction of the overlapping image displacement in the multiple overlapping image is the direction of the misalignment between the overlapping images. The direction is provided for each pixel or each predetermined unit area in the multiple overlapping image. The direction is determined by image acquisition conditions for the acquisition of the multiple overlapping image. The direction is stored in the overlapping image displacement direction storage section 103 as additional information on the image.

The overlapping image displacement measurement section 10B is composed of a filtering section 104, a filtered image storage section 105, a similarity calculation section 103, and overlapping image displacement calculation section 107.

The following are both input to the filtering section 104: multiple overlapping image information read by the multiple overlapping image read section 102 of the image acquisition section 10A and the information on the overlapping image displacement direction read from the overlapping image displacement direction storage section 103.

The filtering section 104 filters the multiple overlapping image from the multiple overlapping image read section 102 as described below. The filtering section 104 then stores the filtered multiple overlapping image in the filtered image storage section 105.

Data on the filtered multiple overlapping image stored in the filtered image storage section 105 is read to the similarity calculation section 106. The similarity calculation section 106 calculates the similarity in the filtered multiple overlapping image. The similarity is output to the overlapping image displacement calculation section 107.

The similarity calculation section 106 calculates the similarity of the overlapping image displacement direction read from the overlapping image displacement direction storage section 103. Here, the autocorrelation value is used as the similarity. The autocorrelation value is calculated in the overlapping image displacement direction to enable a reduction in time required to calculate the autocorrelation value. If the information on the overlapping image displacement direction cannot be acquired or no such information is present, the autocorrelation value is acquired in all directions in two-dimensional space.

The overlapping image displacement calculation section 107 detects a second peak in the autocorrelation value from the similarity calculation section 106 in connection with a one-dimensional variation direction of the multiple overlapping image. The overlapping image displacement calculation section 107 this calculates the displacement between the overlapping images.

Here, the arithmetic operation in the similarity calculation section 106 corresponds to the calculation of the autocorrelation value expressed by Formula 1. However, the arithmetic operation in the similarity calculation section 106 is not limited to the Formula 1 type. Any type of arithmetic operation may be used provided that the arithmetic operation calculates the similarity between the overlapping images contained in the multiple overlapping image.

For example, another example of the arithmetic operation in the similarity calculation section 106 is a type that calculates a sum of squared difference (SSD). To calculate the SSD, the arithmetic operation in the similarity calculation section 106 uses the following instead of the Formula 1 type.

$${y}_{2} ( i ) = {y}_{1} ( i + τ ) \\ R ( τ ) = {\sum }_{i ∈ Ω} {( {y}_{1} ( i ) - {y}_{2} ( i ) )}^{2} \qquad ( 2 )$$

Furthermore, the similarity calculation section 106 may include an intensity ratio acquisition section that acquires the intensity ratio of signals for the overlapping images contained in the multiple overlapping image so that the intensity ratio can be utilized in the similarity calculation section 106. For example, it is assumed that the intensity ratio is used to calculate the SSD. Then, if the intensity ratio of the signals for the overlapping images contained in the multiple overlapping image is l:γ, either one of y₁ and y₂ in Formula 2 is multiplied by γ to allow the calculation accuracy of the SSD to be improved. That is, the following formula is given.

$${y}_{2} ( i ) = {y}_{1} ( i + τ ) \\ R ( τ ) = {\sum }_{i ∈ Ω} {( {y}_{1} ( i ) - γ {y}_{2} ( i ) )}^{2} \qquad ( 3 )$$

The intensity ratio acquisition section may acquire the intensity ratio of the signals for the overlapping images by pre-loading an appropriate value described in the header or the like of the multiple overlapping image, into the intensity ratio acquisition section. Alternatively, the user may set a value for the intensity ratio on the spot.

Here, the arithmetic operation in the similarity calculation section 106 is the calculation of the autocorrelation value expressed by Formula 1. However, the arithmetic operation in the similarity calculation section 106 is not limited to the Formula 1 type. Any type of arithmetic operation may be used provided that the arithmetic operation calculates the similarity between the overlapping images contained in the multiple overlapping image.

Alternatively, for example, another example of the arithmetic operation in the similarity calculation section 106 is a type that calculates a sum of absolute difference (SAD). To calculate the SAD, the arithmetic operation in the similarity calculation section 106 uses the following formula instead of the Formula 1 type.

For example, another example of the arithmetic operation in the similarity calculation section 106 is a type that calculates an SSD. To calculate the SSD, the arithmetic operation in the similarity calculation section 106 uses the following instead of the Formula 1 type.

$${y}_{2} ( i ) = {y}_{1} ( i + τ ) \\ R ( τ ) = {\sum }_{i ∈ Ω} \vert {y}_{1} ( i ) - {y}_{2} ( i ) \vert \qquad ( 4 )$$

Also in the case of Formula 4, the similarity calculation section 106 may include an intensity ratio acquisition section that acquires the intensity ratio of signals for the overlapping images contained in the multiple overlapping image so that the intensity ratio can be utilized in the similarity calculation section 106. For example, if the intensity ratio of the signals for the overlapping images contained in the multiple overlapping image is l:γ, either one of y₁ and y₂ in Formula 4 is multiplied by γ to allow the calculation accuracy of the SAD to be improved. That is, the following formula is given.

$${y}_{2} ( i ) = {y}_{1} ( i + τ ) \\ R ( τ ) = {\sum }_{i ∈ Ω} \vert {y}_{1} ( i ) - γ {y}_{2} ( i ) \vert \qquad ( 5 )$$

Now, the operation of the first embodiment will be described.

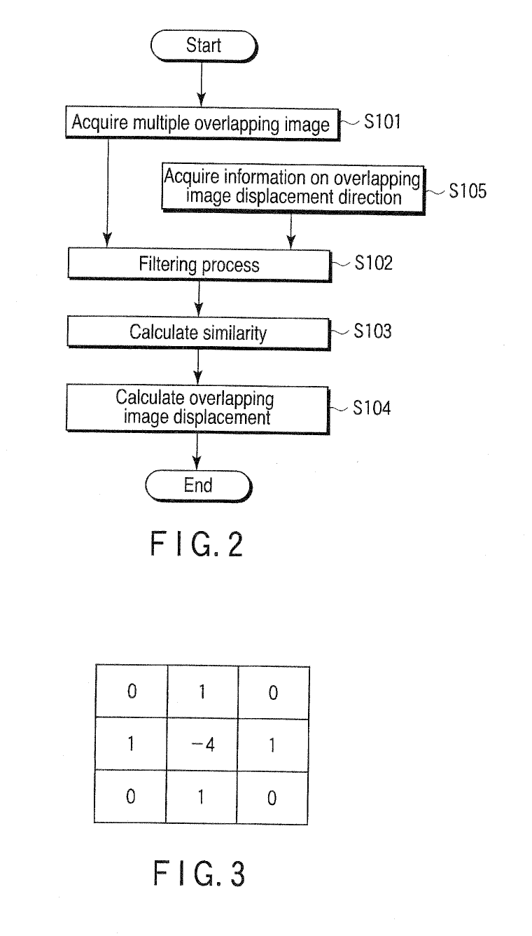

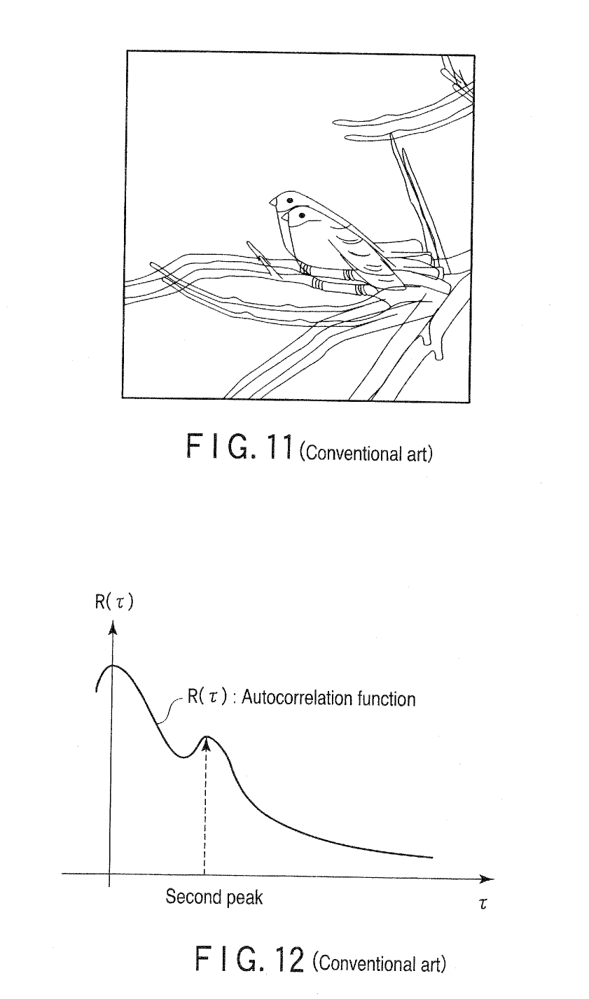

FIG. 2 is a flowchart showing the contents of a process executed by the image processing apparatus 10. At the beginning of the process, the image acquisition section 10A acquires, for example, such a multiple overlapping image as described above with reference to FIG. 11. The image acquisition section 10A then stores the multiple overlapping image in the image storage section 101 (step S101).

The multiple overlapping image read section 102 reads the multiple overlapping image stored in the image storage section 101. The multiple overlapping image read section 102 then sends the multiple overlapping image to the filtering section 104 of the overlapping image displacement measurement section 10B. The filtering section 104 then performs filtering (step S102).

The filtering performed on the multiple overlapping image by the filtering section 104 is high-pass filtering, or bandpass filtering corresponding to a combination of a high-pass filter and a low-pass filter.

FIG. 3 shows an example of a filter configuration used for the high-pass filtering.

FIG. 3 shows the configuration of a Laplacian filter that is a high-pass filter. Another possible high-pass filter of this kind is a preemphasis filter.

In the bandpass filtering, the high-pass filter is combined with a low-pass filter to allow a predetermined spatial-frequency band to pass through.

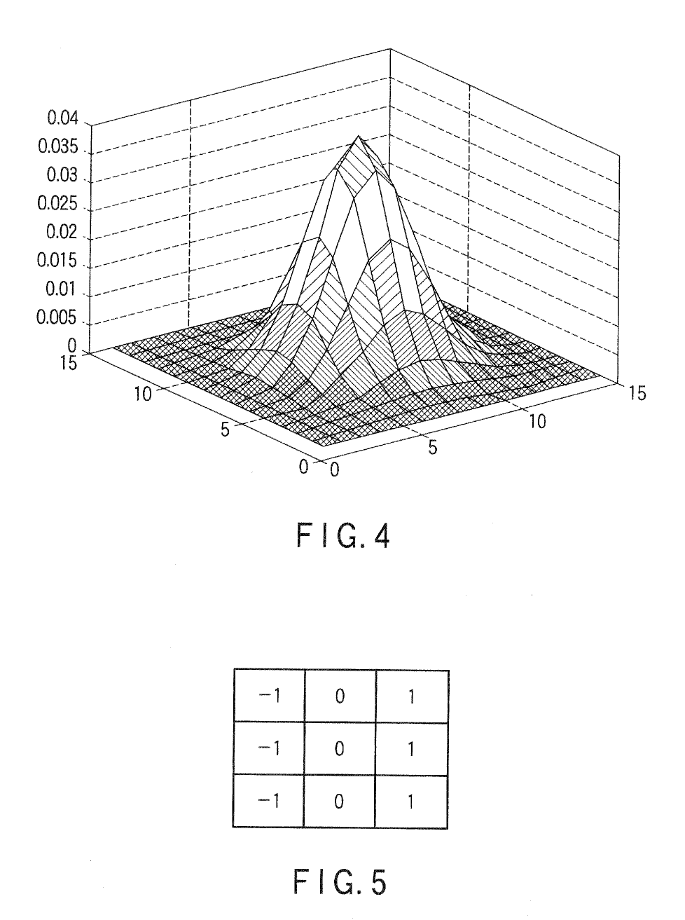

FIG. 4 illustrates the low-pass filter combined with the high-pass filter to form a bandpass filter. Here, FIG. 4 shows the pass characteristics of a Laplacian Of Gaussian (LOG) filter.

Instead of the LOG filter, a low-pass filter such as a difference of Gaussian (DOG) filter may be combined with the high-pass filter to make up a bandpass filter.

The DOG filter is described in David G. Lowe, “Distinctive Image Features from Scale-invariant Keypoints”, International Journal of Computer Vision, 60, 2 (2004), pp. 91-110.

Alternatively, the multiple overlapping image may be filtered as follows. Information on the overlapping image displacement direction is read from the overlapping image displacement direction storage section 103 (step S105). The filtering section 104 then performs filtering in the overlapping image displacement direction read from the overlapping image displacement direction storage section 103 (step S102).

Also in this case, the high-pass filtering may be performed in the overlapping image displacement direction, or the bandpass filtering may be performed by combining a high-pass filter and a low-pass filter.

Possible high-pass filters used in the overlapping image displacement direction include the above-described filters, a differential filter, a Prewitt filter, and a Sobel filter.

FIG. 5 shows the configuration of the Prewitt filter, which is a high-pass filter.

Possible low-pass filters combined with the high-pass filter to form a bandpass filter operating in the overlapping image displacement direction include the LOG filter and DOG filter as in the case of the multiple overlapping image.

As described above, the filtering section 104 performs filtering and stores the results of the filtering in the filtered image storage section 105. The filtered multiple overlapping image stored in the filtered image storage section 105 is read to the similarity calculation section 106, which then calculates similarity (step S103). Here, the autocorrelation value is used as the similarity. The autocorrelation value can be calculated using, for example, Formula 1. As described above, the similarity calculated by the similarity calculation section 106 is not limited to the autocorrelation value. Any other similarity evaluation indicator such as the SSD or SAD may be used.

The overlapping image displacement calculation section 107 uses the autocorrelation value calculated by the similarity calculation section 106 to calculate the displacement between the overlapping images based on the position of the second peak as described with reference to FIG. 12 (step S104). The distance between the first and second peaks corresponds to the displacement between the overlapping images.

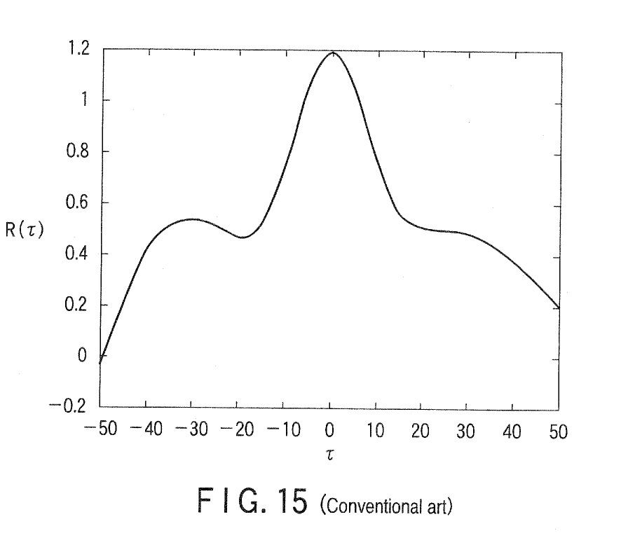

FIG. 15 shows the relationship between the autocorrelation value and the overlapping image displacement τ obtained using the overlapping image displacement calculation section 107 without performing the filtering in step 102 in FIG. 2.

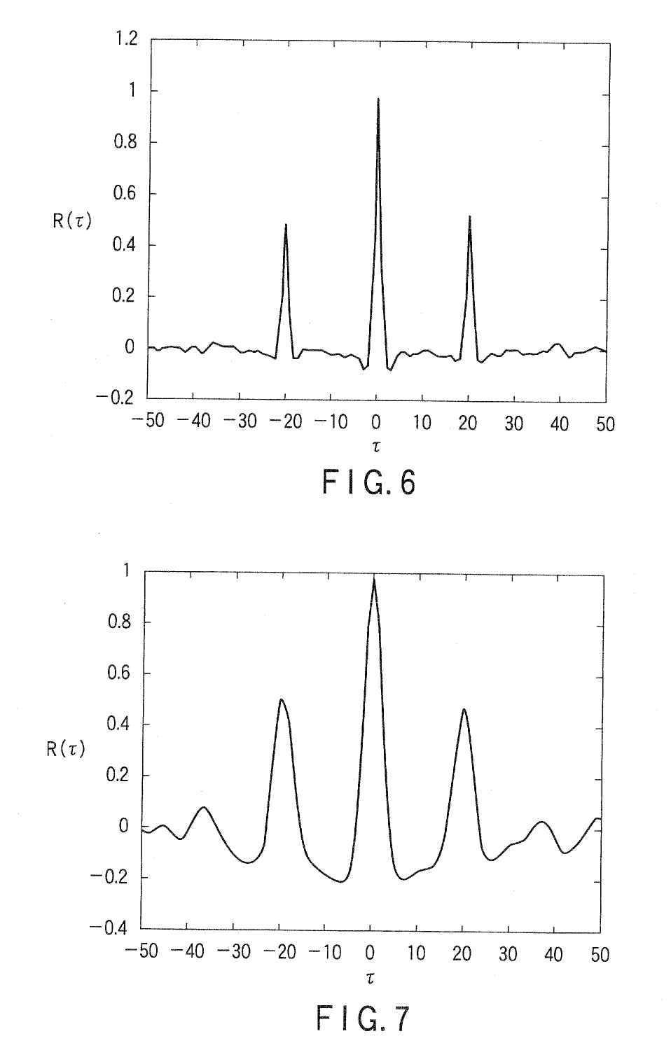

FIG. 6 illustrates the results of the calculation performed by the overlapping image displacement calculation section 107 when the filtering section 104 executes a high-pass filtering process on the multiple overlapping image using the Laplacian filter shown in FIG. 3, described above. The second peak fails to be detected if no filtering is performed as shown in FIG. 15. However, FIG. 6 shows a very clear second peak of the autocorrelation value.

As described above, the second peak is difficult to detect when no filtering is performed. However, the filtering enables a clear second peak to be detected.

In particular, when the filtering section 104 performs high-pass filtering on the multiple overlapping image in association with the information on the overlapping image displacement direction read from the overlapping image displacement direction storage section 103, the position of the second peak can be clearly detected in a shorter time. Thus, based on the distance between the first and second peaks, the overlapping image displacement calculation section 107 can more quickly calculate the displacement between the overlapping images.

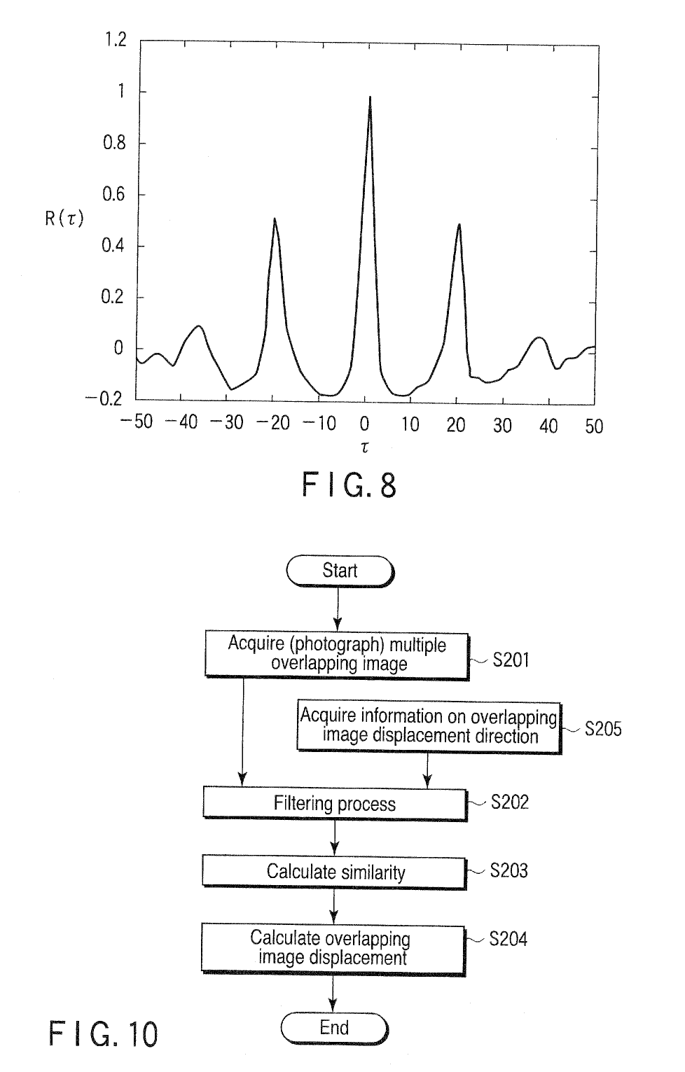

FIG. 7 illustrates the results of the calculation performed by the overlapping image displacement calculation section 107 when the filtering section 104 executes, on the multiple overlapping image, the bandpass filtering corresponding to the combination of the Laplacian filter shown in FIG. 3 and the LOG filter the pass characteristics of which are shown in FIG. 4. Also in this case, FIG. 7 shows that the second peak of the autocorrelation value is detected much more clearly than in the case where no filtering is performed as shown in FIG. 15.

Although the detected peak portions in FIG. 7 are wider than those in FIG. 6, FIG. 7 shows that the position of the second peak is clearly detected. Thus, the overlapping image displacement calculation section 107 can accurately calculate the displacement between the overlapping images.

Furthermore, when the filtering section 104 performs a high-pass filtering process on the multiple overlapping image in association with information on an image formation position varying direction read from the overlapping image displacement direction storage section 103, the position of the second peak can be detected more clearly than in the calculation shown in FIG. 7, described above. Thus, the overlapping image displacement calculation section 107 can more accurately calculate the displacement between the overlapping images.

FIG. 8 illustrates the results of the calculation performed by the overlapping image displacement calculation section 107 when the filtering section 104 executes, on the multiple overlapping image, a high-pass filtering process using the Prewitt filter shown in FIG. 5, described above, in association with the information on the overlapping image displacement direction read from the overlapping image displacement direction storage section 103.

The detection results for the widths of the peak portions shown in FIG. 8 are intermediate between those shown in FIG. 6 and those shown in FIG. 7. The position of the second peak can also be detected much more clearly than in the case where no filtering is performed as shown in FIG. 15. Thus, the overlapping image displacement calculation section 107 can accurately calculate the displacement between the overlapping images.

Thus, the above-described embodiment enables the displacement between the overlapping images to be more accurately measured without being affected by the target multiple overlapping image and the photographing state of the multiple overlapping image.

In addition, when filtering is performed in association with the direction of the displacement between the overlapping images, specification of the overlapping image displacement direction for which the autocorrelation value is calculated enables the process to be executed in a shorter time. Additionally, the present embodiment is unlikely to be affected by the multiple overlapping image or the photographing state of the multiple overlapping image. Therefore, the displacement between the overlapping images can be more accurately and quickly measured.

Furthermore, the above-described embodiment uses the high-pass filter for the filtering portion 104. However, the displacement between the overlapping images can be accurately calculated by using the high-pass filter to extract only high-frequency components from the spatial-frequency components of the multiple overlapping image and calculating the autocorrelation value.

Moreover, the above-described embodiment uses the bandpass filter for the filtering section 104. However, the displacement between the overlapping images can be more accurately calculated by using the bandpass filter to extract only high-frequency components from the spatial-frequency components of the multiple overlapping image while removing noise, and calculating the autocorrelation value.

Furthermore, the above-described embodiment uses the information on the displacement between the overlapping images read from the overlapping image displacement direction storage section 103, and uses the high-pass filter or bandpass filter for the filtering section 104. However, additionally, filtering with the low-pass filter may be performed in a direction orthogonal to the overlapping image displacement direction.

For example, the high-pass filter performs filtering along the overlapping image displacement direction obtained from the overlapping image displacement direction storage section 103, whereas the low-pass filter performs filtering along the direction orthogonal to the overlapping image displacement direction. The present embodiment thus extracts only the high-frequency components from the spatial-frequency components of the multiple overlapping image without being affected by noise. As a result, the overlapping image displacement can be more accurately calculated. Furthermore, the autocorrelation value has only to be calculated for the given overlapping image displacement direction. This enables a further reduction in processing time.

Alternatively, instead of the filtering process executed by the bandpass filter formed by combining the low-pass filter with the high-pass filter along the overlapping image displacement direction obtained from the overlapping image displacement direction storage section 103, a filtering process may be carried out by the low-pass filter along the direction orthogonal to the overlapping image displacement direction. Thus, the overlapping image displacement can be accurately calculated. Furthermore, the autocorrelation value has only to be calculated for the given overlapping image displacement direction. This enables a further reduction in processing time.

### Second Embodiment

A second embodiment in which the image processing apparatus according to the present invention is applied to an image acquisition apparatus will be described below with reference to the drawings.

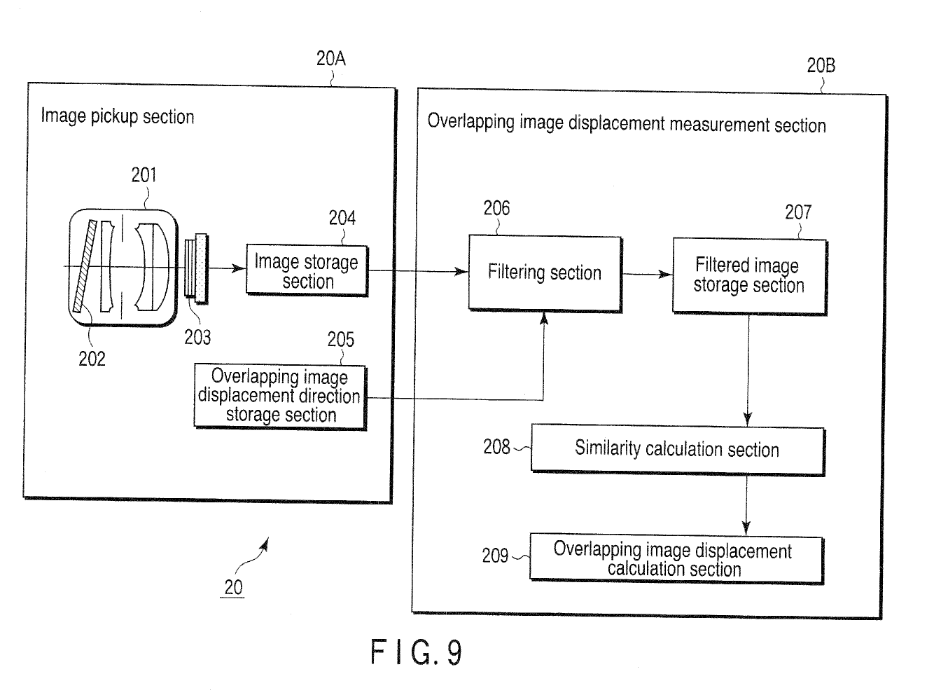

FIG. 9 shows the configuration of a functional circuit in an image acquisition apparatus 20 providing an image acquisition function according to the second embodiment. Reference numbers 20A and 20B denote an image pickup section and an overlapping image displacement measurement section, respectively. FIG. 10 is a flowchart showing the contents of a process executed by the image acquisition apparatus 20.

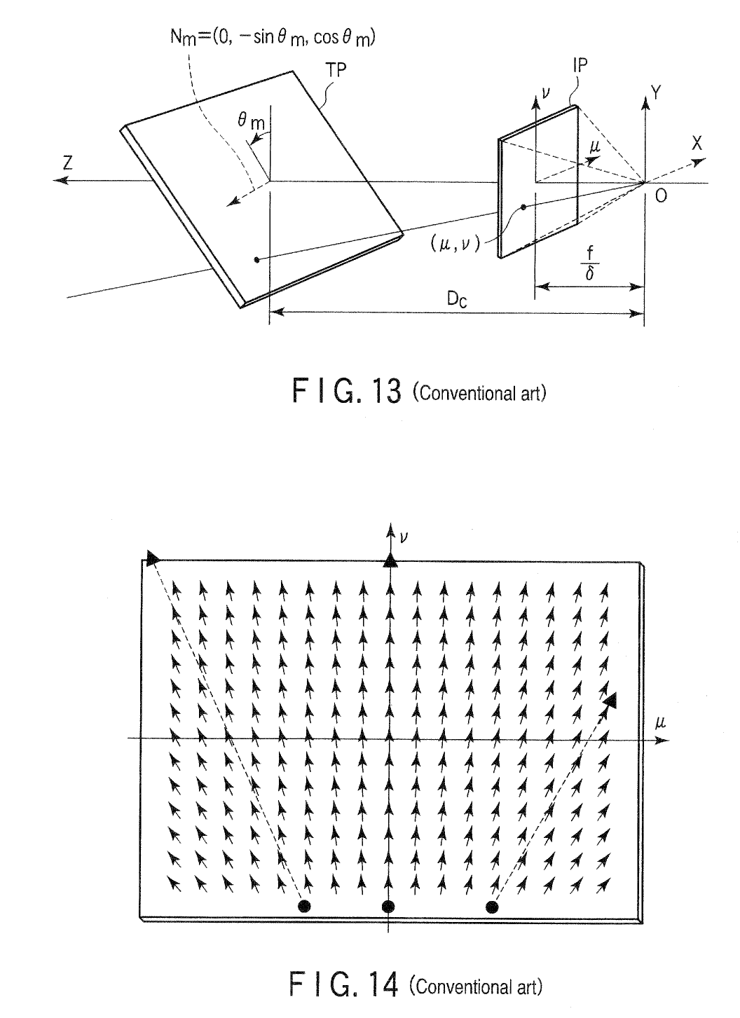

The image pickup section 20A includes an image pickup optical system 201, an image pickup device 203, an image storage section 204, and an overlapping image displacement direction storage section 205. The image pickup optical system 201 includes a multiplexing section 202 located on a subject side along a photographing optical axis. For example, a transparent plate TP shown in FIG. 13 may be used as the multiplexing section 202. In this case, the image pickup optical system 201 including the multiplexing section 202 photographs the same subject via different optical paths. Then, a plurality of images of the same subject can be formed on the image pickup device 203 at different positions.

The multiplexing section 202 is not limited to the configuration in FIG. 13. The multiplexing section 202 may have any other configuration provided that the configuration provides overlapping images that are misaligned.

A signal for the multiple overlapping image provided by the image pickup device 203 is digitized via an automatic gain control (AGC) amplifier, an analog-to-digital converter, and the like (these components are not shown in the drawings). The digitized signal is then stored the image storage section 204.

Then, the multiple overlapping image stored in the image storage section 204 is read to the overlapping image displacement measurement section 20B.

Furthermore, the overlapping image displacement direction storage section 205 stores the overlapping image displacement direction corresponding to the multiple overlapping image stored in the image storage section 204. The overlapping image displacement direction corresponds to the direction of the misalignment between overlapping images. The overlapping image displacement direction is provided for each pixel or each predetermined unit area in the multiple overlapping image. In the present embodiment, the overlapping image displacement direction in the multiple overlapping image is determined by image acquisition conditions for the acquisition of the multiple overlapping image. The overlapping image displacement direction is stored in the overlapping image displacement direction storage section 205 as additional information on the image. The information on the image formation position varying direction stored in the overlapping image displacement direction storage section 205 is read to the overlapping image displacement measurement section 20B.

The overlapping image displacement measurement section 20B includes a filtering section 206, a filtered image storage section 207, a similarity calculation section 208, and an overlapping image displacement calculation section 209. The configuration and functions of the overlapping image displacement measurement section 20B are essentially similar to those of the overlapping image displacement measurement section 10B in FIG. 1, described above. The overlapping image displacement measurement 20B acquires information from the image storage section 204 and the overlapping image displacement direction storage section 205 in place of the multiple overlapping image readout section 102 and overlapping image displacement direction storage section 103 in FIG. 1; the information acquired from the image storage section 204 is similar to that acquired from the multiple overlapping image read section 102, and the information acquired from the overlapping image displacement direction storage section 205 is similar to that acquired from the overlapping image displacement direction storage section 103. The overlapping image displacement measurement section 20B thus executes a process similar to that executed by the overlapping image displacement measurement section 10B. The details of the overlapping image displacement measurement section 20B will not be described.

FIG. 10 is a flowchart showing the contents of a process executed by the image acquisition apparatus 20. Process contents duplicating those in FIG. 2, described above, are simplified, and differences from the first embodiment will be described in detail.

In step S201, the image pickup section 20A performs a photographing operation to acquire such a multiple overlapping image as described above with reference to FIG. 11. The image pickup section 20A stores the multiple overlapping image in the image storage section 204.

In step S202, the multiple overlapping image stored in the image storage section 204 is filtered by the filtering section 206 of the overlapping image displacement measurement section 20B.

In subsequent step S203, the filtered multiple overlapping image is read to the similarity calculation section 208, which then calculates the similarity. Here, the autocorrelation value is used as the similarity.

As described above, the similarity calculated by the similarity calculation section 208 is not limited to the autocorrelation value. Any other similarity evaluation indicator such as the SSD or SAD may be used.

In step S204, the overlapping image displacement calculation section 209 uses the calculated autocorrelation value to calculate the displacement between the overlapping images based on the position of the second peak. The distance between the first and second peaks corresponds to the displacement between the overlapping images.

Furthermore, in the filtering of the multiple overlapping image, the information on the overlapping image displacement direction may be read from the overlapping image displacement direction storage section 205 (step S205). The filtering section 206 may then perform filtering in the overlapping image displacement direction read from the overlapping image displacement direction storage section 205 (step S202).

Thus, when a multiple overlapping image is obtained by means of photographing using the image pickup optical system 201 and image pickup device 203 of the image pickup section 20A, the above-described embodiment enables the displacement between the overlapping images to be more accurately measured without being affected by the multiple overlapping image or the photographing state of the multiple overlapping image.

In addition, filtering is performed in association with the direction of the displacement between the overlapping images. Thus, specification of the overlapping image displacement direction for which the autocorrelation value is calculated enables the process to be executed in a shorter time. Additionally, the present embodiment is unlikely to be affected by the multiple overlapping image or the photographing state of the multiple overlapping image. Therefore, the displacement between the overlapping images can be more accurately and quickly measured.

In the description of the first and second embodiments, the double overlapping image is used in which two subject images are present in the multiple overlapping image.

In this manner, the apparatus is configured with the multiple overlapping image limited to the double overlapping image. Then, the apparatus not only deals with many cases of image processing involving the measurement of the overlapping image displacement but also enables improvement of the accuracy with which the displacement between multiple subject images is calculated and the speed at which the displacement is calculated.

However, the multiple overlapping image to be measured according to the present invention is not limited to the double overlapping image, described above in the embodiments. Expanding the configuration of the apparatus allows the apparatus to deal easily with a multiple overlapping image with at least three overlapping images.

Furthermore, the types of the high and low-pass filters, used for the filtering sections 104 and 206 in the first and second embodiments, respectively, are not limited to those described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image processing apparatus comprising:
an image acquisition section acquiring a multiple overlapping image in which a subject image is multiplexed;
a filtering section filtering the multiple overlapping image acquired by the image acquisition section;
a similarity calculation section calculating similarity between overlapping images contained in the multiple overlapping image filtered by the filtering section; and
an overlapping image displacement calculation section using the similarity obtained by the similarity calculation section to calculate overlapping image displacement in the multiple overlapping image.

2. The image processing apparatus according to claim 1, wherein the similarity calculation section is an autocorrelation value calculation section calculating an autocorrelation value for the overlapping images contained in the multiple overlapping image.

3. The image processing apparatus according to claim 1, wherein the similarity calculation section is a sum of squared difference (SSD) calculation section calculating an SSD for the overlapping images contained in the multiple overlapping image.

4. The image processing apparatus according to claim 1, wherein the similarity calculation section is a sum of absolute difference (SAD) calculation section calculating an SAD for the overlapping images contained in the multiple overlapping image.

5. The image processing apparatus according to claim 3 or 4, further comprising an intensity ratio acquisition section acquiring an intensity ratio of signals for the overlapping images contained in the multiple overlapping image,
wherein upon calculating the SSD or the SAD, the SSD calculation section or the SAD calculation section, respectively, uses the intensity ratio calculated by the intensity ratio acquisition section.

6. The image processing apparatus according to claim 1, further comprising overlapping image displacement direction storage section in which an overlapping image displacement direction of the overlapping images contained in the multiple overlapping image are stored,
wherein the filtering section performs filtering in the overlapping image displacement direction stored in the overlapping image displacement direction storage section.

7. The image processing apparatus according to claim 1, wherein the filtering section performs filtering with a high-pass filter.

8. The image processing apparatus according to claim 1, wherein the filtering section performs filtering with a bandpass filter.

9. The image processing apparatus according to claim 6, wherein the filtering section performs the filtering with a bandpass filter in the overlapping image displacement direction stored in the overlapping image displacement direction storage section and performs the filtering with a low-pass filter in a direction orthogonal to an image formation position varying direction.

10. The image processing apparatus according to claim 6, wherein the filtering section performs the filtering with a bandpass filter in the overlapping image displacement direction stored in the overlapping image displacement direction storage section and performs the filtering with a low-pass filter in a direction orthogonal to the overlapping image displacement direction.

11. The image processing apparatus according to claim 1, wherein the multiple overlapping image is a double overlapping image.

12. An image processing method comprising: an acquisition step of acquiring a multiple overlapping image in which a subject image is multiplexed;
a filtering step of filtering the multiple overlapping image acquired in the image acquisition step;
a similarity calculation step of calculating similarity between overlapping images contained in the multiple overlapping image filtered in the filtering step; and
an overlapping image displacement calculation step of using the similarity obtained in the similarity calculating step to calculate overlapping image displacement in the multiple overlapping image.
